(19) United States
(12) Patent Application Publication
(10) Pub. No.: US 2023/0286454 A1
(43) Pub. Date: Sep. 14, 2023

(54) VEHICLE BUMPER

(71) Applicant: AUTOTECH ENGINEERING S.L., Amorebieta-Etxano, Bizkaia (ES)

(72) Inventors: Daniel PALO, Luleå (SE); Martin JONSSON, Gammelstad (SE)

(73) Assignee: AUTOTECH ENGINEERING S.L., Amorebieta-Etxano, Bizkaia (ES)

(21) Appl. No.: 18/009,104

(22) PCT Filed: Jun. 9, 2021
(86) PCT No.: PCT/EP2021/065397

§ 371 Date: Dec. 8, 2022

(30) Foreign Application Priority Data
Jun. 10, 2020 (SE) 2050689-5

(51) Int. Cl. B60R 19/18; B60R 19/24

(52) U.S. Cl. CPC B60R 19/18; B60R 19/24

(57) ABSTRACT

The present invention relates to a vehicle bumper beam for attachment to a vehicle body, which bumper beam is extending generally horizontally when attached to a vehicle body, said bumper beam having a generally U-shaped section, providing a central portion and side walls; wherein at least one local area of at least one side wall is provided with reduced tensile strength in comparison to major portions of said bumper beam, and wherein said at least one local area with reduced tensile strength is placed adjacent attachment points for the bumper beam to the vehicle body.

### TECHNICAL AREA

The present application relates to a bumper beam to be used in a crash management system of a vehicle.

### BACKGROUND OF INVENTION

Vehicle bumper assemblies have been developed for a number of years that may have a design with crash boxes attached to a vehicle body and a transversally extending bumper beam. The bumper beam may have an open U-shaped cross-sectional shape, a so-called mono-block design. The bumper beam with this design may have its U-shape open either outwards or towards the vehicle body.

Even though this type of vehicle bumper assembly has proven to have a number of advantages, there are some drawbacks and/or challenges that have been discovered in crash situations. In some instances, the deformation behaviour in a crash may not be robust enough. For instance, there have been occurrences where the bumper beam will be moved or will flip up or down during deformation.

Conventionally, this behaviour has been addressed by changing the geometry of the beam but this has had limited desired effect. Moreover, these geometrical changes have entailed added material, which is undesirable.

Further, there might be issues with the load distribution during a crash. Sometimes the structure of the vehicle will have different strength near the upper attachment point to the crash boxes in comparison to the lower attachment point. This drawback has been very difficult to take care of with the conventional design of the bumper beam since the thickness of the material used is the same throughout the beam.

Another challenge has been occurrence of cracks when the beam is exposed to crash forces. It has been seen that is some cases the material plane strain deformation limit is exceeded during a crash. This may inevitably lead to cracks and consequently to reduced load handling, thereby reducing efficiency and the reliability of the solution.

In order to improve the crash handling abilities of the bumper assembly, higher strength materials have been considered but some of these material grades show lower bendability in comparison to the conventionally used materials for this type of application, which makes the unsuitable for a bumper assembly.

In summary, the conventional way of tuning crash response and load level has been to modify geometry, such as change of thickness, adding or removing geometrical features or adding or removing holes. Most of these measures requires costly and time-consuming tool changes and/or modifications.

Some attempts have been made for providing bumper beams that display different properties in different areas, improving crash force handling. For instance, US 2018/0361964 discloses a bumper assembly having a bumper beam attached to two crush cans. The beam has been thermally treated so that the end portions of the bumper beam outside the crush cans have a less tensile strength than the middle section of the bumper beam. The thermal treatment comprises providing a lower temperature to the end portions before performing a hot-stamping process. The aim of a so produced bumper beam is to selectively deform upon impact. A drawback with this solution is that it is difficult to really tailor the behaviour because it is difficult to have local targeted areas with different temperatures during the hot-stamping. The method of US 2018/0361964 may only be used for larger sections such as outer ends of a bumper beam where the whole section is treated.

EP3604043 A1 discloses a bumper beam with an inverted hat profile provided with high-strength portions and low-strength portions. One major aspect is that the high-strength portion is at least a middle portion with the low-strength portions outside of the high-strength portion. In most of the embodiments described and shown, the low-strength portions are placed at a distance from and inside the crash boxes and not adjacent them and thus high-strength portions are adjacent the crash boxes. In one embodiment, the low-strength portions extend all the way out to the outer ends of the bumper beam. The low-strength portions are placed in the hat member and cover the whole hat member as seen in a cross-sectional view.

This solution is also difficult to tailor due to the heating process that requires relatively large areas of the bumper beam to be treated differently. There is thus a need for improvements in the so-called mono block design of vehicle bumper assemblies.

### BRIEF DESCRIPTION OF INVENTION

The present invention aims at providing a bumper beam having improved performance and abilities to handle impact. This aim is obtained by a bumper beam according to the features of the independent patent claims. Preferable embodiments form the subject of the dependent patent claims.

According to the present application a vehicle bumper beam is provided for attachment to a vehicle body, which bumper beam is extending generally horizontally when attached to a vehicle body. The bumper beam may have a generally U-shaped section, providing a central portion and side walls. According to a favourable aspect, at least one local area of at least one side wall may be provided with reduced tensile strength in comparison to major portions of said bumper beam. Further the at least one local area with reduced tensile strength may be placed adjacent attachment points for the bumper beam to the vehicle body. This provides a possibility of designing the force handling abilities of the bumper beam in a very tailored manner, depending on the desired function and performance of the bumper beam. This is especially obtained in that the areas with reduced tensile strength are local in contrast to the state of the art bumper beams where those sections with reduced strength are much larger and thus cannot provide the same design possibilities for optimal performance of the bumper beam.

In this regard, the lower or the upper side wall may be provided with a local area with reduced tensile strength. As an alternative, both the lower and the upper side wall may be provided with a local area with reduced tensile strength. As a further alternative, both the lower and the upper side wall may be provided with a local area with reduced tensile strength having similar properties. As yet a further alternative, the lower or the upper side wall is provided with a local area with reduced tensile strength having different properties compared to the other side wall.

Preferably, the at least one local area may be thermally treated to provide the reduced tensile strength. In this respect, the at least one local area may be treated on a pre-hardened bumper beam. The treatment may comprise a thermal treatment of the local area obtained by heating by laser. As an alternative, selected areas of a blank to be formed to a bumper beam may be covered with a heat absorbing material while selected local areas are left untreated and wherein the blank may be heated during a time period such that the covered areas reach a hardening temperature while the uncovered local areas are at a temperature below the hardening temperature.

Moreover, the heated blank may be hot formed. In this regard, the formed blank may be allowed to cool in a hot forming die. As an alternative, the formed blank is allowed to cool outside a hot forming die.

These and other aspects of, and advantages with, the present invention will become apparent from the following detailed description of the invention and from the accompanying drawings.

### BRIEF DESCRIPTION OF DRAWINGS

In the following detailed description of the invention, reference will be made to the accompanying drawings, of which

FIG. 1 is a schematic perspective view of a bumper beam modified according to the present invention,

FIG. 2 is a cross-sectional view of the bumper beam of FIG. 1 taken along the plane II-II, and

FIGS. 3 and 4 show different processes for producing a modified bumper beam of FIG. 1.

### DETAILED DESCRIPTION OF THE INVENTION

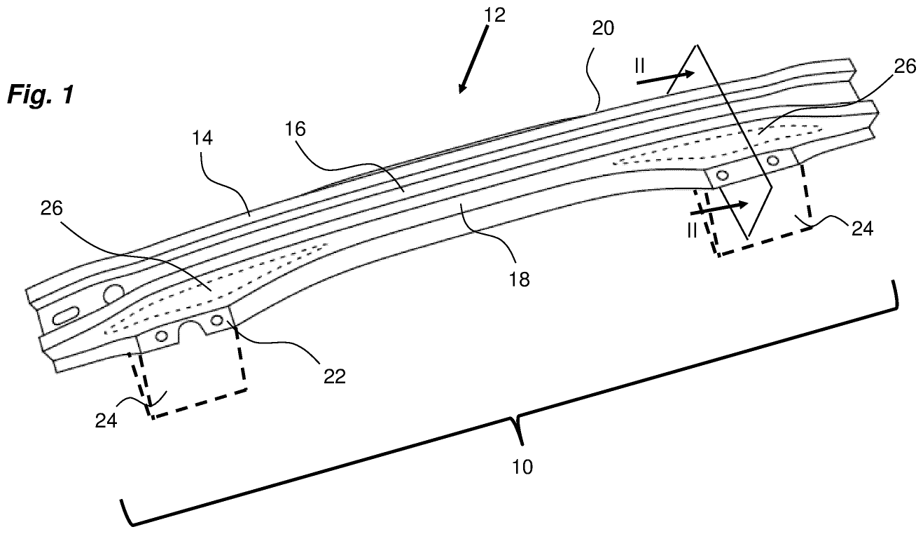

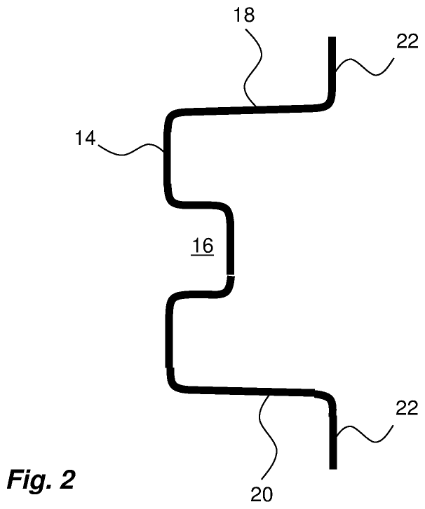

According to one aspect of the invention as shown in the drawings, a vehicle bumper for a vehicle bumper assembly 10 has been developed. The vehicle bumper beam 12, preferably made in one piece, is generally horizontal when attached to a vehicle and is extending generally transversely, FIGS. 1 and 2. The bumper beam 12 preferably has a general U-shape as seen in a cross-section with a central portion 14, generally vertical when attached. The central portion may have an elongated profiled section or bead 16 for added strength. The bumper beam 12 is further provided with two generally horizontal side walls, one upper 18 and one lower 20. The bumper beam 12 could either have the U-shaped section open towards the vehicle body or alternatively out from the vehicle.

The bumper beam is designed and intended to be attached to attachment points of a body of a vehicle such as the side beams of a white body of a vehicle. The bumper beam may be attached by appropriate means such as by welding or by bolts. For this reason, the bumper beam may be provided with suitable flanges 22 that enable the attachment.

As an alternative to attachment points, the bumper beam may be attached to at least two crash boxes 24. The crash boxes are in turn designed to be attached to a vehicle body, preferably both at the front part and at the rear part of the vehicle body. The crash boxes 24 may be attached by appropriate means such as welding or by bolts.

In either case, the bumper beam 12 is according to the invention provided with tailored properties in certain specific and pre-chosen local areas 26. More specifically these local areas 26 are preferably located on the side walls 18, 20 of the bumper beam 12 and are in particular located adjacent attachment points of the bumper beam to the vehicle as seen in FIG. 1. The tailored local areas 26 may be on the upper 18, the lower 20 or on both side walls 18, 20 depending on the desired function of bumper beam 12 when exposed to crash forces. For instance, this enables a more precise deformation initiation for example in terms of geometrical position and collapse load level.

Further, if the side walls 18, 20 have different properties, it is possible to tune the collapse load on the upper side wall 18 and the lower side wall 20 individually, improving the load distribution situation. Another advantage is that the risk of cracks is greatly reduced in these tailored local areas. Further advantage is that using tailored local areas eliminates the need for tool modifications and/or tool changes. Even though tailored local areas have been described and shown to be arranged on the side walls, it is of course to be understood that tailored local areas may be located also on the central portion 14 and/or that the tailored local areas 26 may extend from a side wall 18, 20 to the central portion 14, depending on the desired function of the bumper beam when subjected to crash loads.

According to a favourable solution, the tailored local areas 26 are treated such that the material properties are altered and modified. For instance, these tailored local areas 26 may be provided with reduced tensile strength in relation to the tensile strength of the rest of the bumper beam. In this regard, as mentioned above, if for instance local areas with reduced strength are placed either on the upper or lower side wall, the side walls will be provided with different properties. Also, if local areas are placed on both the upper and the lower side walls, the local areas may be treated such that both have reduced tensile strength but one local area has a lower tensile strength than the other local area.

The tailored local areas may be created by very controlled local heating of pre-selected local areas. According to one aspect of the invention, laser heating may be used for the local heating, providing possibilities for very controlled and local heating and tempering. The laser may in that respect be mounted on a specific control system such as a robot arm, the movement of which may be performed by suitable control programs. As an alternative, the laser may be stationary and positioned in relation to a fixture in which the bumper beam to be treated is placed and held. Further, a number of lasers may be positioned in arrays so as to cover the local area that is to be treated as described, for instance if LED lasers are used. In this aspect, fibreoptic cables may be used in order to direct the laser light towards the local areas to be treated.

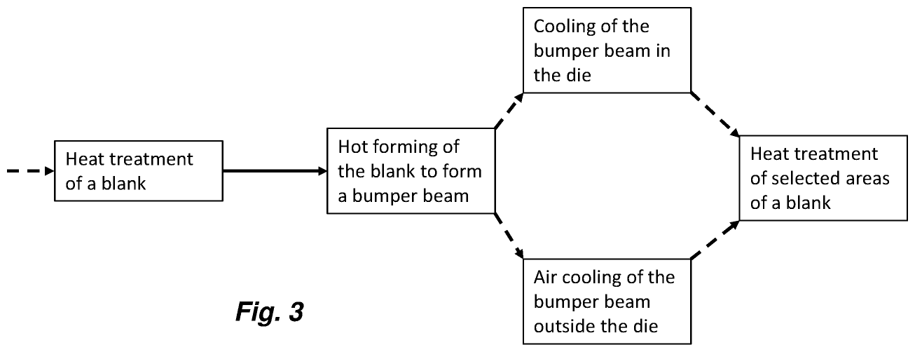

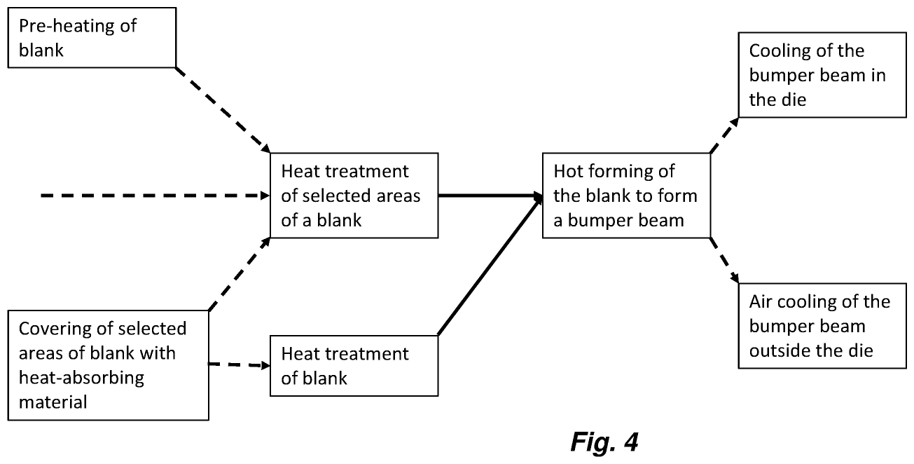

The local heating and tempering may in this aspect be performed after the bumper beam has been hardened as seen in FIG. 3, wherein the hardening may be performed by press hardening in a forming die wherein the component is formed, hardened and let to cool somewhat in a die. Further, an air hardening steel alloy may be used wherein the formed component is removed from the die and let to cool, and thereby harden, outside the die. In any event, subsequent local heating and tempering may be performed in exactly the areas wherein the desired properties are wanted as described above. Thus, the same dies that are used for conventional hardening of the whole bumper beam may be used also for the tailored bumper beams.

According to another aspect, the local heating may be performed on areas that are to be hardened in a subsequent die pressing process, FIG. 3. These selected areas are then heated over the austenite forming temperature while the non-selected local areas, that are to have reduced tensile strength as described above are not heated over this temperature. As an alternative, the whole blank to be formed to a bumper beam is heated in for example a conveyer oven to a temperature below the austenite temperature and then the selected areas that are to be hardened are subjected to local heating above the austenite temperature in order to have these areas hardened.

Other means of locally altering the properties of the bumper beam is to use a cover material or coating on the blank to be formed as a bumper beam in order to increase the heat absorption on certain areas, and to leave certain local areas uncovered, such as in particular the tailored zones. When such a coated blank is exposed to heat, for example when placed in a furnace, the coated areas will be heated more quickly than the uncoated local areas. This provides an opportunity to heat a steel blank in a furnace that has a temperature above the austenite forming temperature of the blank. The covered areas will then reach the desired temperature before the uncovered local areas and when the blank then is transferred to a press-hardening die, where the covered areas, having reached the desired temperature, will harden while the uncovered local areas, that have not reached a temperature above the austenite forming temperatures, will not be hardened.

It is to be understood that the embodiment described above and shown in the drawings is to be regarded only as a non-limiting example of the invention and that it may be modified in many ways within the scope of the patent claims.

1. A vehicle bumper beam for attachment to a vehicle body, which bumper beam is extending generally horizontally when attached to a vehicle body,
said bumper beam having a generally U-shaped section, providing a central portion and upper and lower side walls;
wherein at least one local area of at least one side wall is provided with reduced tensile strength in comparison to major portions of said bumper beam,
wherein said at least one local area with reduced tensile strength is placed adjacent attachment points for the bumper beam to the vehicle body.

2. The vehicle bumper beam according to claim 1, wherein the lower or the upper side wall is provided with a local area with reduced tensile strength.

3. The vehicle bumper beam according to claim 1, wherein both the lower side wall and the upper side wall are provided with a local area with reduced tensile strength.

4. The vehicle bumper beam according to claim 3, wherein both the lower and the upper side wall is provided with a local area with reduced tensile strength having similar properties.

5. The vehicle bumper beam according to claim 2, wherein the lower or the upper side wall is provided with a local area with reduced tensile strength having different properties compared to the other side wall.

6. The vehicle bumper beam according to claim 1, wherein the said at least one local area is thermally treated to provide the reduced tensile strength.

7. The vehicle bumper beam according to claim 6, wherein said at least one local area is treated on a pre-hardened bumper beam.

8. The vehicle bumper beam according to claim 6, wherein said at least one thermally treated local area is obtained by heating by laser.

9. The vehicle bumper beam according to claim 6, wherein selected areas of a blank to be formed to a bumper beam are covered with a heat absorbing material while selected local areas are left untreated and wherein the blank is heated during a time period such that the covered areas reach a hardening temperature while the uncovered local areas are at a temperature below the hardening temperature.

10. The vehicle bumper beam according to claim 9, wherein the heated blank is hot formed.

11. The vehicle bumper beam according to claim 10, wherein the formed blank is allowed to cool in a hot forming die.

12. The vehicle bumper beam according to claim 7, wherein said at least one thermally treated local area is obtained by heating by laser.

13. The vehicle bumper beam according to claim 7, wherein selected areas of a blank to be formed to a bumper beam are covered with a heat absorbing material while selected local areas are left untreated and wherein the blank is heated during a time period such that the covered areas reach a hardening temperature while the uncovered local areas are at a temperature below the hardening temperature.
